(19) United States
(12) Patent Application Publication
(10) Pub. No.: US 2009/0272224 A1
(43) Pub. Date: Nov. 5, 2009

(54) INDEXED SEGMENTED CRANKSHAFT

(76) Inventor: Ted Hollinger, Algona, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/401,608

(22) Filed: Mar. 10, 2009

Related U.S. Application Data
(60) Provisional application No. 61/035,534, filed on Mar. 11, 2008.

(51) Int. Cl. F16C 3/10

(52) U.S. Cl. 74/597

(57) ABSTRACT

A segmented crankshaft design with interchangeable parts is shown. The new crankshaft design allows for rapid customization. The system comprises specifically designed segments that are indexed to fit together to form a complete crankshaft.

### BACKGROUND OF THE INVENTION

1. Field of the Invention

The present invention relates to the manufacturing and assembly of a crankshaft for an internal combustion or diesel engine. In particular, the invention comprises of a crankshaft that is made up of pieces or segments that are assembled together with the proper segment indexing to achieve a design that could not be achieved by casing or machining as a single component.

2. Background of the Art

Crankshafts are generally made by molding cast iron. Snowmobiles and other specialized engines have used press together crankshafts, some with ball bearings. In each case the crankshaft has been designed to fit a specific engine. Furthermore each crankshaft is designed for a specific stroke. There is a need for a design that allows for changing the crankshaft design without having to make a new mold and take all the associated steps. The desired design would allow for the assembly of crankshaft segments from an inventory of segment parts and/or facilitate the design and fabrication of one or more of these segments to allow a custom crankshaft design. A flexible quick turn around solution is needed.

### SUMMARY OF THE INVENTION

An object of the present invention is to provide an improved apparatus and method for designing and manufacturing crankshafts. These and other objects of the present invention will become apparent to those skilled in the art upon reference to the following specification, drawings, and claims.

The present invention intends to overcome the difficulties encountered heretofore. To that end, a crankshaft design that uses segments in such a way that when assembled form a crankshaft with unique features.

### BRIEF DESCRIPTION OF THE DRAWINGS

FIG. 1 is a view of a standard crankshaft made by molding cast iron.

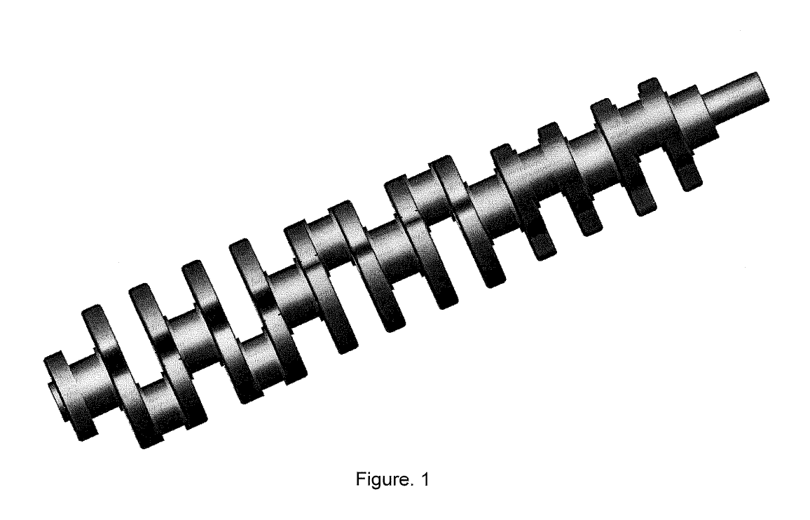

FIG. 2 is a drawing of the rear main bearing and crankshaft end plate.

FIG. 3 is a drawing of the front main bearing and crankshaft front shaft.

FIG. 4 is a drawing of the mid engine main bearing.

FIG. 5 is a drawing of the throw and counterweight.

FIG. 6 is a drawing of the rod bearing holder.

FIG. 7 shows how the segments can be bolted together.

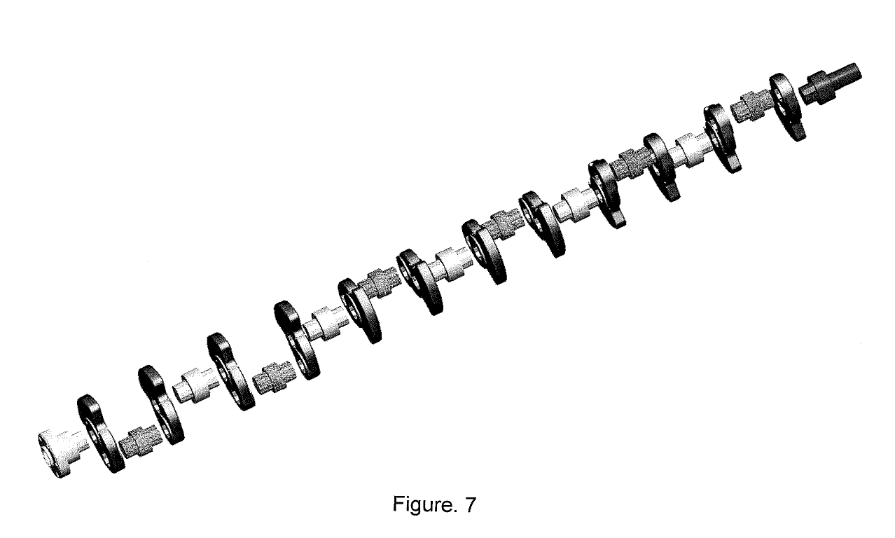

### DETAILED DESCRIPTION OF THE INVENTION

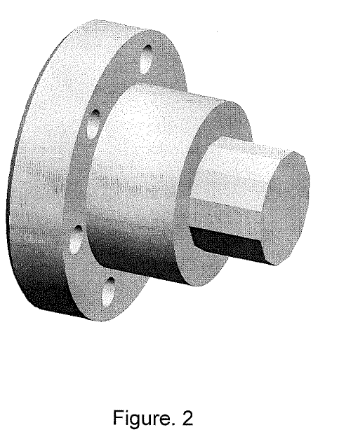

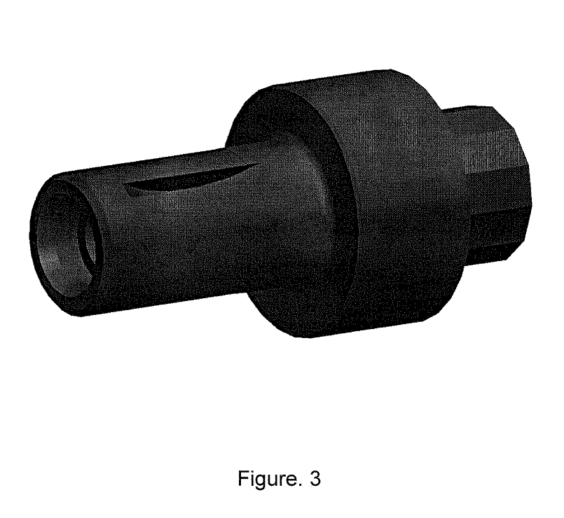

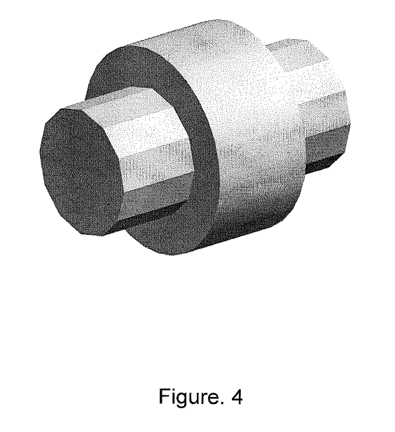

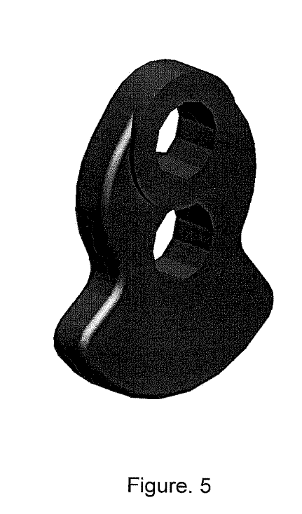

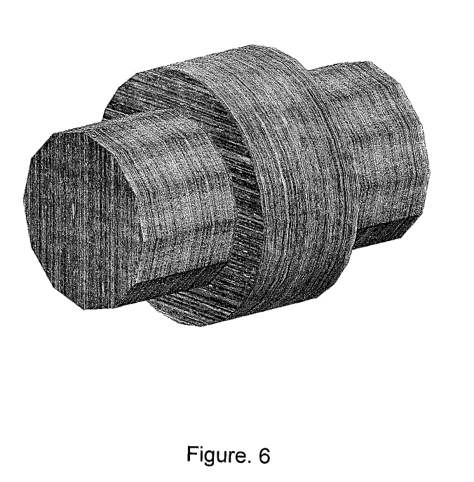

In the following figures are shown the segments for constructing a segment crankshaft. In the Figures is shown both the standard crankshaft and the segmentation for the new crankshaft. The process begins with the design of each segment. FIGS. 2 through 6 show an example of each type of segment. Each segment is designed so that they can be indexed to form a series of crankshafts for engines with different number of cylinders. In our example the indexed is 30 degrees based on a 12 face spline. This allows the segments to form crankshafts for 1, 2, 3, 4 or 6 cylinder engines. Other spline counts can be used to accommodate engines with a different number of cylinders. Thus the design is universal as the manufacturer chooses.

Preferably, the segments could be designed so the crankshaft could be both easily assembled and easily taken apart for repair.

The basic configuration of an indexed segmented crankshaft is made up of five segment types. These types are: 1) rear main bearing and crankshaft end plate (rear drive flange) 2) front main bearing and crankshaft front shaft (front snout) 3) mid engine main bearing (main bearing journal) 4) throw for setting the stroke length and the balance (connecting rod throw with counter weight) and 5) rod bearing holder (connecting rod journal). Each of these pieces can be designed and fabricated so that when assembled they can become a crankshaft. Each of the segments connect together through a splined shaft, denote one of a series of ridges on a shaft which mesh with and equalize the rotation speed of a mating piece, and are designed so that the splines allow the construction of crankshafts from one cylinder up to six cylinders (excluding five cylinders). A shaft with 12 faces would achieve this. A four cylinder engine requires the crankshaft to have throws 90 degrees apart. A six cylinder engine requires the throws to be 60 degrees apart. A 12 face shaft can be indexed in 30 degree increments and can thus meet the requirements. The throw then would have a 12 face opening in it much like a 12 point box end wrench. The precision machining of these 12 faces for both pieces will allow for a very tight fit. All the 12 face openings and 12 face male shaft will have a machined shoulders to square the mating surfaces and will be secured in place with threaded bolt and washers. This is necessary in order to meet and maintain the tolerances for the final crankshaft assembly. The front and rear segments will have a single male 12 face shaft facing into the engine. The mid engine main bearing shaft will have two 12 face male shafts, one on each end. The rod bearing holder will likewise have two male shafts, although they would not need to be of any specific spline or face count. The throws would have two 12 face openings, one to receive the main bearing shaft and one to receive the rod bearing holder. Each of the segments could be made of different materials. Each could multiple interchangeable segments. The throws, for instance could have different stroke lengths and/or different counter balances. The latter would allow for proper balancing in the case of changing from one weight piston to another. Each segment could be designed for conventional oiling or for ball bearing. It is also possible to build a crankshaft that would give different stroke lengths for the same engine. This could be interesting for engines that use an n+n cylinder control system, where n represents one half of the number of cylinders for a given engine. This could allow one half of the engine to develop more power than the other half of the engine. This could work well with an engine that operated on gasoline and/or hydrogen. The lower compression half of the engine could be operated on gasoline or hydrogen while the higher compression half of the engine could only operate on hydrogen. Since gasoline produces more power than hydrogen this could be a good comprise when using both fuels.

Frequently, there is a need to test engines under differing conditions and with differing engine configurations. Changing the length of the stroke is a major task. The ability to change the stroke length quickly, especially if the crankshaft could be disassembled easily, would be a help to researchers and racers alike. Another feature is that custom segments could be made in machine shops throughout the world and fit together with the ‘standard’ segments to form unique crankshafts. The segments could be machined from a solid piece of material, cast ala piston rods, cut from flat material , made of sintered metal or assembled from sub pieces and joined together to form a sub assembly.

The foregoing description and drawings comprise illustrative embodiments of the present invention. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A segmented crankshaft design with interchangeable parts comprising specifically designed segments that are indexed to fit together to form a complete crankshaft.
